(19) United States
(12) Patent Application Publication
(10) Pub. No.: US 2022/0309311 A1
(43) Pub. Date: Sep. 29, 2022

(54) COMMEMORATIVE ITEM INCLUDING VIRTUAL COMPONENT

(71) Applicant: Visions Awards, Celina, OH (US)

(72) Inventors: Christopher M. Niekamp, Minster, OH (US); Matthew T. Suzuki, Rockford, OH (US)

(21) Appl. No.: 17/701,122

(22) Filed: Mar. 22, 2022

Related U.S. Application Data
(60) Provisional application No. 63/165,340, filed on Mar. 24, 2021.

(51) Int. Cl. G06K 19/077; G06K 19/06; G06K 19/07

(52) U.S. Cl. CPC G06K 19/07758; G06K 19/06037; G06K 19/0723

(57) ABSTRACT

Commemorative items configured to allow a person encountering a physical commemorative item to access virtual content associated with the commemorative item are disclosed. An exemplary a commemorative item includes a physical commemorative item and a link to a virtual content associated with the physical commemorative item. The link is provided in proximity to the physical commemorative item.

### CROSS-REFERENCE TO RELATED APPLICATIONS

This application claims the benefit of priority to U.S. Provisional Patent Application Ser. No. 63/165,340, filed Mar. 24, 2021, the disclosure of which is incorporated by reference herein in its entirety.

### TECHNICAL FIELD

The present disclosure relates generally to commemorative items, such as awards, and, more particularly, to commemorative items including links to virtual content associated with the commemorative items.

### BACKGROUND

The present disclosure contemplates that commemorative items, such as awards, typically embody physical objects. Generally, the personalization of such physical commemorative items is limited to visible information on the item, and the amount of such personalization may be limited by the space available on the commemorative item. Further, such personalization typically cannot be changed or updated at a later time. Accordingly, the present disclosure contemplates that it may be advantageous to provide commemorative items associated with enhanced personalization capabilities.

### SUMMARY

It is an aspect of the present disclosure to provide a commemorative item including a physical commemorative item and a link to a virtual content associated with the physical commemorative item. The link is provided in proximity to the physical commemorative item.

In a detailed embodiment, the link may include a visual indicium. The visual indicium may include a QR code. The visual indicium may be displayed on the physical commemorative item in an explicit manner.

In a detailed embodiment, the visual indicium may be displayed on the physical commemorative item in a discreet manner. The visual indicium may include a QR code hidden within a visible graphic on the physical commemorative item.

In a detailed embodiment, the link may include a radio frequency communication device. The radio frequency communication device may include an NFC tag and/or an RFID tag. The radio frequency communication device may be hidden within the physical commemorative item. The radio frequency communication device may be positioned proximate a badge on the physical commemorative item.

In a detailed embodiment, the virtual content may include one or more of a website, a video recording, a musical recording, a payment link, or a social media link. The link may include a static link. The link may include a redirected link.

It is an aspect of the present disclosure to provide a commemorative item system including a commemorative item as described above and a storage medium having the virtual content stored therein.

It is an aspect of the present disclosure to provide a method of manufacturing a commemorative item including obtaining a physical commemorative item, obtaining a link to a virtual content associated with the physical commemorative item, and disposing the link to the virtual content in proximity to the physical commemorative item.

In a detailed embodiment, disposing the link to the virtual content in proximity to the physical commemorative item may include disposing the link in or on the physical commemorative item. Obtaining the physical commemorative item may include manufacturing or customizing the physical commemorative item.

In a detailed embodiment, the method may further include storing the virtual content on a storage medium. The method may further include changing the virtual content on the storage medium.

In a detailed embodiment, storing the virtual content on the storage medium may occur after disposing the link to the virtual content in proximity to the physical commemorative item.

The above and other objects and advantages of the present disclosure shall be made apparent from the accompanying drawings and the description thereof.

### BRIEF DESCRIPTION OF THE DRAWINGS

FIG. 1 is a perspective view of an exemplary physical commemorative item in accordance with the principles of the present disclosure.

FIG. 2 is a perspective view of an alternative exemplary physical commemorative item in accordance with the principles of the present disclosure.

FIG. 3 is a perspective view of an alternative exemplary physical commemorative item in accordance with the principles of the present disclosure.

FIG. 4 is a schematic illustration of an exemplary commemorative item system in accordance with the principles of the present disclosure.

### DETAILED DESCRIPTION

Exemplary embodiments according to the present disclosure are described and illustrated below to encompass devices, methods, and techniques relating to commemorative items. Of course, it will be apparent to those of ordinary skill in the art that the embodiments discussed below are examples and may be reconfigured without departing from the scope and spirit of the present disclosure. It is also to be understood that variations of the exemplary embodiments contemplated by one of ordinary skill in the art shall concurrently comprise part of the instant disclosure. However, for clarity and precision, the exemplary embodiments as discussed below may include optional steps, methods, and features that one of ordinary skill should recognize as not being a requisite to fall within the scope of the present disclosure.

The present disclosure includes, among other things, commemorative items, and, more particularly, commemorative items including virtual components, as well as methods relating thereto. The present disclosure contemplates that commemorative items, such as awards, typically embody physical objects. With increasing technical capabilities, enhanced personalization and content of awards (or other commemorative items) is possible. For example, some embodiments according to at least some aspects of the present disclosure may allow a person encountering a physical commemorative item to access virtual content associated with the physical commemorative item, such as by using a smart phone or tablet.

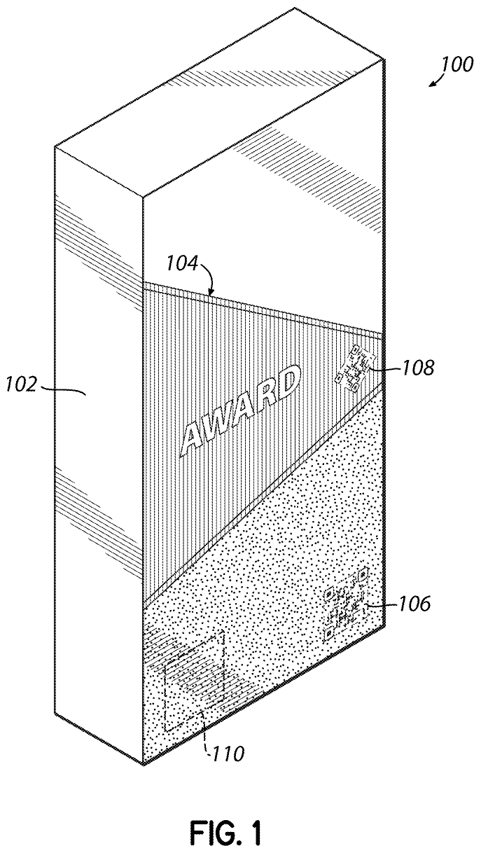

Referring to FIG. 1, an exemplary physical commemorative item 100 may comprise a physical object 102, such as an award object comprising customized visual indicia 104. For example, customized visual indicia 104 may include text or graphics identifying the purpose of the physical commemorative item 100, a recipient of the physical commemorative item 100, or any other information or images as may be desired.

The exemplary physical commemorative item 100 may further include a link to virtual content associated with the physical commemorative item. For example, the link may include a visual indicium, such as a Quick Response (“QR”) code 106, 108. An exemplary QR code 106, 108 may include a matrix barcode, which may be read by an imaging device, such as a camera associated with a smart phone or tablet.

In some exemplary embodiments, a link comprising a visual indicium may be displayed on the physical commemorative item 100 in a discreet manner (e.g., hidden within a logo, picture, and/or graphic). For example, hidden QR code 106 of FIG. 1 is shown hidden within a visible graphic on the front face of the physical commemorative item 100. In some exemplary embodiments, a hidden visual indicium may be configured so that at initial glance, an individual encountering the physical commemorative item 100 may not notice the hidden visual indicium. For example, a hidden visual indicium may be inherent in a portion of the artwork of the physical commemorative item 100.

In some exemplary embodiments, a link comprising a visual indicium may be displayed on the physical commemorative item in an explicit manner. For example, explicit QR code 108 of FIG. 1 is visibly present in an obvious manner on the front face of the physical commemorative item 100. In some exemplary embodiments, an explicit visual indicium may be provided in a contrasting color compared to the background.

In some exemplary embodiments, the link to the virtual content associated with physical commemorative item 100 may include a radio frequency communication device 110. Generally, the radio frequency communication device 110 may be configured to communicate information and/or data to and/or from a compatible user device, such as to facilitate accessing virtual content using the user device. For example, the link may comprise a near field communication (“NFC”) tag and/or a radio frequency identification (“RFID”) tag. In some exemplary embodiments, an NFC tag may be configured to communicate with an NFC-enabled device, such as a smart phone or tablet. In some exemplary embodiments, an RFID tag may be configured to communicate with an RFID-enabled device, such as an RFID reader device. In some exemplary embodiments, a radio frequency communication device 110 may be hidden within a physical commemorative item 100. In some exemplary embodiments, a radio frequency communication device 110 may be positioned proximate a badge (e.g., a visible marking or other identifier) on a physical commemorative item 100.

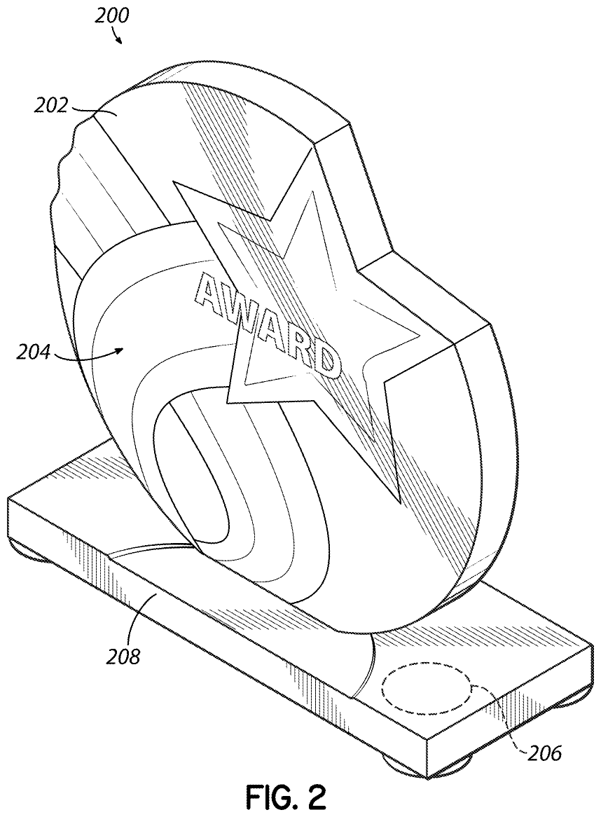

Referring to FIG. 2, an exemplary physical commemorative item 200 may comprise a physical object 202, such as an award object comprising customized visual indicia 204. In this exemplary embodiment, an NFC tag 206 comprising a link to virtual content is hidden within a base portion 208 of the physical object 202. In alternative exemplary embodiments, an RFID tag may be used instead of or in addition to the NFC tag 206.

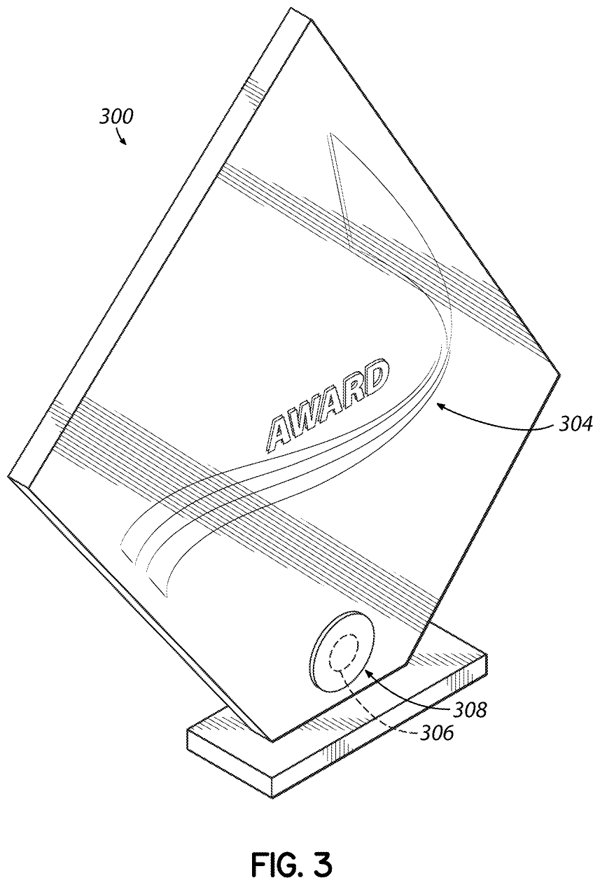

Referring to FIG. 3, an exemplary physical commemorative item 300 may comprise a physical object 302, such as an award object comprising customized visual indicia 304. In this exemplary embodiment, an NFC tag 306 is disposed in or on the physical commemorative item 300 proximate a badge 308. In some exemplary embodiments, utilizing a badge 308 in connection with an NFC tag 306 may make the physical commemorative item 300 more aesthetically pleasing and/or may facilitate consistent application of NFC tags 306 to various configurations (e.g., sizes and/or shapes) of physical commemorative items 300. In alternative exemplary embodiments, an RFID tag may be used instead of or in addition to the NFC tag 306.

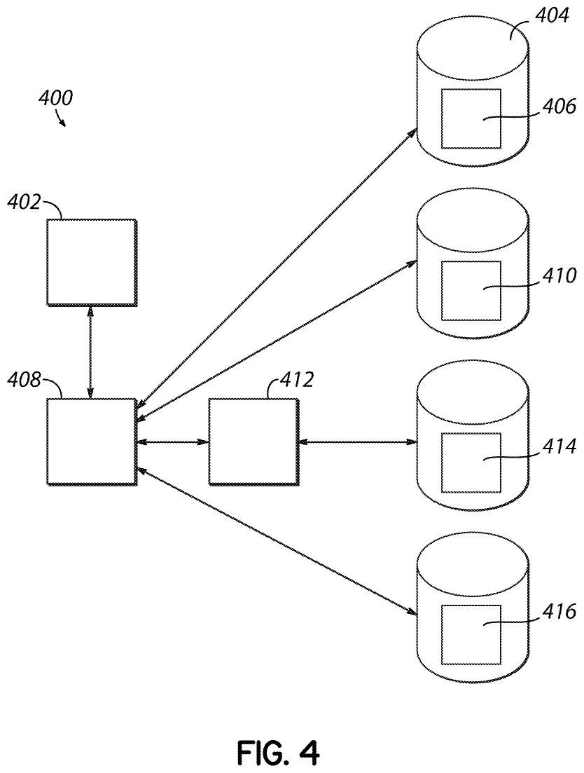

FIG. 4 is a simplified schematic view of an exemplary commemorative item system 400, according to at least some aspects of the present disclosure. Commemorative item system 400 may include a physical commemorative item 402 (such as physical commemorative items 100, 200, 300) and/or a storage medium 404 having virtual content 406 associated with the physical commemorative item 402 stored thereon. In some exemplary embodiments, the virtual content 406 may be accessed using a user device 408 (e.g., a tablet or smart phone). For example, the user device 408 may be used to read a link (e.g., QR code 106, 108 and/or radio frequency communication device 110, such as NFC tags 206, 306). The user device 408 may be operatively connected, such as via the internet, to the storage medium 404 to access the virtual content 406 by utilizing the information in the link.

In some exemplary embodiments, the link may comprise a direct, static link. For example, the link may comprise a static URL at which virtual content 406, 410 may be accessed. Generally, in some exemplary embodiments, a user device 408 may utilize the link to obtain virtual content 406, 410 directly, such as without redirection. In some exemplary embodiments, the link may be established when the physical commemorative item 402 is created and may not be subsequently updated.

In some exemplary embodiments, the link may comprise a redirected link. For example, the link may comprise a URL associated with an intervening server 412, which may be configured to obtain virtual content 414 and provide it to the user device 408. In some exemplary embodiments, the link may comprise a URL associated with an intervening server 412, which may be configured to direct the user device 408 to obtain the virtual content 416 from another internet location. In some exemplary embodiments, redirected links may be configured to allow the virtual content 414, 416 to be updated or changed without modifying the link provided in connection with the physical commemorative item 402. For example, a redirected link may initially access virtual content comprising a video recording pertaining to the physical commemorative item 402 (e.g., an award), but may later be changed to access virtual content comprising a document describing accomplishments associated with the physical commemorative item 402.

Exemplary virtual content 406, 410, 414, 416 may include, without limitation, websites, video recordings, music recordings, payment systems, and/or social media locations. For example, websites may include links to product offerings on commerce sites and/or to a web page associated with a company that purchased an award. In the context of a sports award, an exemplary website may include sports statistics associated with the award and/or an athlete.

Exemplary video recordings may include videos explaining accomplishments and/or videos including presentation of the award (physically and/or virtually). For example, an executive of a company may record a personal tribute to an employee who earned an award. As another example, a company may record an awards ceremony during which an award is presented. After the event, a redirected link may be updated to access a video recording of the presentation of the award. Yet another example may include a welcome package for new employees including a desktop award. The award may include one or more links to a company representative welcoming the new employee to the company individually and/or explaining company values, for example. In the context of a sports award, exemplary video content may include sporting event highlights and/or a tribute to the athlete.

Exemplary music recordings may be accessed to improve the experience while viewing an award. Exemplary payment systems may be configured to facilitate donations or purchases, such as via Venmo, PayPal, or similar financial institutions. Exemplary social media locations may facilitate discussions about experiences, such as receiving an award, working for a company that gave an award, etc.

While exemplary commemorative items have been illustrated and described herein in the form of awards, it will be appreciated that commemorative items in accordance with the present disclosure may have various other forms. As non-limiting examples, other types of commemorative items may include memorials (such as gravesites, war memorials, etc.), donor recognition walls, wayfinding walls, and various other physical items, for example.

While the present disclosure includes a description of various exemplary embodiments, and while these exemplary embodiments have been described in considerable detail, it is not intended to restrict or in any way limit the scope of the appended claims to such detail. The various features shown and described herein may be used alone or in any combination. Additional advantages and modifications will readily appear to those skilled in the art. The disclosure in its broader aspects is therefore not limited to the specific details, representative apparatus and methods, and illustrative examples shown and described. Accordingly, departures may be made from such details without departing from the spirit and scope of the general inventive concept.

What is claimed is:

1. A commemorative item, comprising:
a physical commemorative item; and
a link to a virtual content associated with the physical commemorative item;
wherein the link is provided in proximity to the physical commemorative item.

2. The commemorative item of claim 1, wherein the link comprises a visual indicium.

3. The commemorative item of claim 2, wherein the visual indicium comprises a QR code

4. The commemorative item of claim 2, wherein the visual indicium is displayed on the physical commemorative item in an explicit manner.

5. The commemorative item of claim 2, wherein the visual indicium is displayed on the physical commemorative item in a discreet manner.

6. The commemorative item of claim 5, wherein the visual indicium comprises a QR code hidden within a visible graphic on the physical commemorative item.

7. The commemorative item of claim 1, wherein the link comprises a radio frequency communication device.

8. The commemorative item of claim 7, wherein the radio frequency communication device comprises an NFC tag and/or an RFID tag.

9. The commemorative item of claim 7, wherein the radio frequency communication device is hidden within the physical commemorative item.

10. The commemorative item of claim 7, wherein the radio frequency communication device is positioned proximate a badge on the physical commemorative item.

11. The commemorative item of claim 1, wherein the virtual content comprises one or more of a website, a video recording, a musical recording, a payment link, or a social media link.

12. The commemorative item of claim 1, wherein the link comprises a static link.

13. The commemorative item of claim 1, wherein the link comprises a redirected link.

14. A commemorative item system, comprising:
the commemorative item of claim 1; and
a storage medium having the virtual content stored therein.

15. A method of manufacturing a commemorative item, the method comprising:
obtaining a physical commemorative item;
obtaining a link to a virtual content associated with the physical commemorative item; and
disposing the link to the virtual content in proximity to the physical commemorative item.

16. The method of claim 15, wherein disposing the link to the virtual content in proximity to the physical commemorative item comprises disposing the link in or on the physical commemorative item.

17. The method of claim 15, wherein obtaining the physical commemorative item comprises manufacturing or customizing the physical commemorative item.

18. The method of claim 15, further comprising storing the virtual content on a storage medium.

19. The method of claim 18, further comprising changing the virtual content on the storage medium.

20. The method of claim 18, wherein storing the virtual content on the storage medium occurs after disposing the link to the virtual content in proximity to the physical commemorative item.
